(19) United States
(12) Patent Application Publication
(10) Pub. No.: US 2026/0327867 A1
(43) Pub. Date: Oct. 22, 2026

(54) LOOM AND METHOD FOR MANUFACTURING A SHAPED FABRIC

(71) Applicant: SAFRAN AIRCRAFT ENGINES, Paris (FR)

(72) Inventors: Maxime GUILLOT, MOISSY-CRAMAYEL (FR); Romain CHAUFOUR, MOISSY-CRAMAYEL (FR); Hubert Jean Marie FABRE, MOISSY-CRAMAYEL (FR)

(73) Assignee: SAFRAN AIRCRAFT ENGINES, Paris (FR)

(21) Appl. No.: 19/105,544

(22) PCT Filed: Aug. 22, 2023
(86) PCT No.: PCT/FR2023/051285

§ 371 Date: Feb. 21, 2025

(30) Foreign Application Priority Data
Aug. 22, 2022 (FR) 2208431

(51) Int. Cl. D03J 1/06; B29C 70/24; B29C 70/48; B29K 105/08; D03D 41/00

(52) U.S. Cl. CPC D03J 1/06; B29C 70/24; B29C 70/48; D03D 41/004; B29K 2105/0845; D10B 2505/02

(57) ABSTRACT

A loom for manufacturing a fabric having a variable thickness across a width of the fabric includes heald wires, connected to a mechanism that moves the heald wires in a vertical direction between a reference position and a first position for opening warp yarns, each heald wire being provided with an eye through which one of the warp yarns passes, a rapier arranged downstream of the heald wires that draws a weft yarn from a bobbin, and a holding device that holds the fabric arranged downstream of the heald wires and the rapier. The holding device includes a first bearing surface and a second bearing surface arranged on either side of the fabric in order to compress the fabric between the first and second bearing surfaces. The first bearing surface is shaped so as to be partially complementary to a surface of the fabric.

### TECHNICAL FIELD

The invention relates to the manufacturing of a fabric, in particular a shaped three-dimensional fabric, that is to say having a variable thickness over its width. Such a fabric can be used, in particular, as a reinforcement or preform in the manufacturing of composite objects by resin transfer moulding, in particular for aeronautical applications.

### PRIOR ART

Three-dimensional fabrics (3D) can be used as reinforcements or preforms in composite objects manufactured by resin transfer moulding (RTM).

Depending on the geometry of the object, the reinforcement does not always have a constant thickness over its entire width. In particular, the surface of the mould on which the reinforcement is placed before injection of the resin may not be developable. In this case, in order to avoid the formation of folds during the placing of the reinforcement in the imprint of the mould, it may be advantageous that the fabric has a variable thickness, for example, a smaller thickness at its edges than at its centre.

Such a fabric can be manufactured using a Jacquard loom, which is described, in particular, in document FR 3 074 195 A1.

FIG. 1 illustrates a Jacquard loom 10 used for producing a three-dimensional fabric obtained by multilayer weaving together of a plurality of layers of warp yarns 30 and a plurality of layers of weft yarns 31.

The loom 10 is equipped with a Jacquard mechanism 11 supported by a superstructure that is not shown in FIG. 1.

The loom 10 also comprises a harness 20 consisting of a bottom board 21 and heald wires or heddles 22, each heddle 22 being connected at one end to a control hook 12 of the Jacquard mechanism 11 and at the other end to one of the return springs 13 fixed to the frame 14 of the loom 10.

Each heddle 22 comprises an eye 23 passed through by a warp yarn 30. The heddles 22 and their associated eye 23 are driven with a substantially vertical oscillating movement represented by the double arrow F under the traction forces respectively exerted by the control hooks 12 and the return springs 13.

The heddles 22 make it possible to lift certain warp yarns 30 and to thus create a shed 15, in other words an opening between lower and upper sheets of warp yarns 30 enabling the introduction of weft yarns 31 by means of a rapier 40.

The rapier 40 is provided at its end with a clamp 41 which grasps a weft yarn 31 from a bobbin 50 in order to place it through the opening between the sheets of warp yarns 30 created by the shed 15, the weft yarn 31 being cut using a knife 60 after its positioning in the shed 15.

A comb 70 present upstream of the rapier 40 is then folded down in order to pack the one or more weft yarns introduced into the shed 15.

The rapier 40 is then ready to again grasp a new weft yarn 31 from the bobbin 50 and to place it either again in the shed 15, or in a different shed depending on the weaving defined.

Thus, a fabric T is gradually formed having a 3D or multilayer weave of warp yarns 30 and weft yarns 31.

The loom 10 further comprises a device for holding the fabric T, present downstream of the heddles 22 and the rapier 40.

The holding device 80 comprises a lower jaw 81 and an upper jaw 82 each connected to an actuation means (not shown). Said holding device makes it possible, in particular, to control the position of the opening point of the shed 15, in other words the location from which two sheets of warp yarns diverge from one another in the upstream direction.

A difficulty encountered during the weaving of a three-dimensional fabric is the expansion of the fabric, in other words the phenomenon of swelling of the fabric due to the interweaving of the warp and weft yarns.

Due to this expansion, the three-dimensional fabric leaving the loom has a thickness greater than the intended thickness, which can generate defects during the implementation of the RTM method.

In particular, the reinforcement can form local bulges, which can give rise to pinching of the fabric during closing of the mould, manifest, in the final object, by zones for which the mechanical properties are not controlled.

Document WO 2021/048486 thus describes a method for closing a mould intended to prevent such pinching.

### BRIEF DESCRIPTION OF THE INVENTION

An object of the invention is therefore to design a loom making it possible to control the expansion of the shaped fabric and thus to improve the RTM method that can be subsequently implemented.

For this purpose, the invention proposes a Jacquard loom for manufacturing a fabric, in particular a two-dimensional or three-dimensional fabric, having a variable thickness over its width by weaving together a plurality of warp yarns and a plurality of weft yarns, said loom comprising:
a plurality of heald wires, connected to a mechanism capable of moving the heald wires in a vertical direction between a reference position and a first position for opening the warp yarns, each heald wire also being provided with an eye through which one of the warp yarns passes,
a rapier arranged downstream of the heald wires, capable of drawing a weft yarn from a bobbin,
a device for holding the fabric arranged downstream of the plurality of heald wires and the rapier, comprising at least two bearing surfaces, including at least a first bearing surface and a second bearing surface arranged on either side of the fabric in order to compress the fabric between said bearing surfaces.

Said loom is characterised in that at least the first bearing surface is shaped so as to be at least partially complementary to a surface of the fabric.

Due to the variation in thickness of the fabric, at least one surface of the fabric is non-planar.

In the present text, the term “shaped so as to be at least partially complementary”, shall mean that the first bearing surface has a non-planar shape, the concavity of which is oriented towards the surface of the fabric. Preferably, the bearing surface at least partially matches the non-planar surface of the fabric, in other words, when the first bearing surface is brought towards the surface of the fabric in the vertical direction, the distance between the first bearing surface and the surface of the fabric is substantially constant, at least over a part of the width of the fabric.

In the present text, the terms “upstream” and “downstream” extend in the direction of advance of the weaving of the yarns.

Advantageously, the holding device comprises at least one holding bar having said at least one first bearing surface.

In certain embodiments, said holding bar comprises a body and a removable portion carrying the first bearing surface, the removable portion being reversibly connected to the body of the holding bar.

Said removable portion can be in the form of a solid metal bar, on which the first bearing surface is formed.

In certain embodiments, the holding device comprises a table having the second bearing surface, said second bearing surface being planar.

Particularly advantageously, the distance between the first and second bearing surfaces is chosen so as to reduce the expansion of the fabric in order to reach a minimum expansion threshold.

Another object of the invention relates to a method for manufacturing a fabric, in particular a 3D fabric, having a variable thickness over its width, comprising:
weaving a plurality of warp yarns and a plurality of weft yarns by means of a Jacquard loom, as described above, so as to form said fabric, and
application, by the holding device, of a compression of the fabric by means of said first and second bearing surfaces.

Particularly advantageously, the distance between the bearing surfaces is controlled so as to reduce the expansion of the fabric in order to reach a minimum expansion threshold.

In certain embodiments, the warp yarns and weft yarns comprise carbon and/or glass.

Another object of the invention relates to a method for manufacturing a composite object comprising a fabric, in particular a two-dimensional or three-dimensional fabric, having a determined shape, said method comprising:
manufacturing said fabric by the method as described above;
winding a reinforcement formed of a portion of said fabric in an imprint of a mould defining a outer surface of the object;
closing the mould;
introducing a resin into the imprint in order to impregnate the reinforcement.

In certain embodiments, the object has a rotationally symmetric shape.

In particular, the object can be a fan casing, a turbine casing, a nozzle casing or a mixer casing for an aeronautical engine.

### BRIEF DESCRIPTION OF THE FIGURES

Other features and advantages of the invention will become apparent from the detailed description which follows with reference to the appended drawings in which:

FIG. 1 shows an assembled view of a known Jacquard loom;

FIGS. 2A, 2B and 2C are sectional views of a three-dimensional fabric having a variable thickness over its width;

FIG. 3 is a sectional view of the three-dimensional fabric of FIG. 2A and of a bar of the holding device according to an embodiment;

FIG. 4 is a sectional view of the three-dimensional fabric of FIG. 2A and of a bar of the holding device according to the prior art;

FIG. 5 shows an assembled view of a Jacquard loom according to an embodiment of the invention;

FIG. 6 is a graph in principle of the change in expansion as a function of the distance between the bearing surfaces of the holding device.

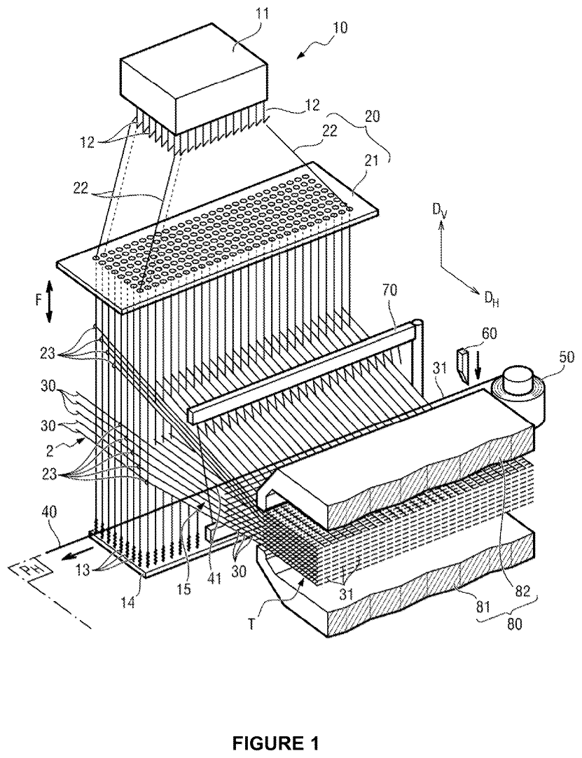

For reasons of legibility of the figures, the drawings have not necessarily been drawn to scale.

Identical reference signs between figures designate identical elements or elements fulfilling the same function.

### DETAILED DESCRIPTION OF THE EMBODIMENTS

The invention relates to the manufacturing of a shaped fabric having a controlled expansion. In the remainder of the text, reference will essentially be made to a three-dimensional fabric, but the description applies equally to a two-dimensional fabric.

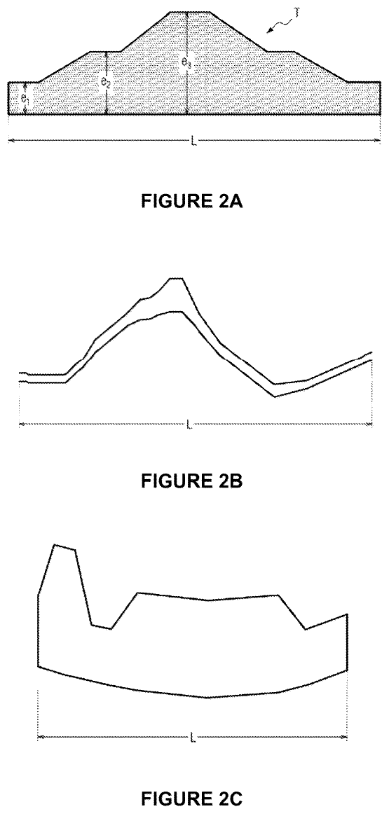

FIG. 2A illustrates an example of a shaped three-dimensional fabric, seen in cross-section. In this example, the fabric has a planar lower surface and a thickness gradually increasing from its edge (thickness e₁) towards its centre (thickness e₃) with an intermediate thickness e₂, thus forming a non-planar upper surface. Of course, this thickness variation profile is given only by way of illustration and is not limiting.

Furthermore, both main surfaces of the fabric may have a non-planar shape.

FIG. 2B illustrates a second example of a shaped three-dimensional fabric, in cross-sectional view.

FIG. 2C illustrates a third example of a shaped three-dimensional fabric, in cross-sectional view.

In general, shaped weaving consists of weaving a profile proportional to the inner profile of the composite object to be produced. In a manner known per se, this profile is obtained by a differential take-off of yarns by means of a non-cylindrical take-off roller which makes it possible to have different lengths of yarns depending on the location of each yarn on the roller.

The expansion of such a fabric can be defined as being the ratio between the total volume occupied by the fabric, as produced by the loom, and a reference volume for this fabric, corresponding, for example, to the smallest volume to which this fabric could be brought by compressing it.

In the invention, the expansion is controlled by the use of a holding device which has a bearing surface shaped so as to be at least partially complementary to the shape of the surface of the fabric facing it.

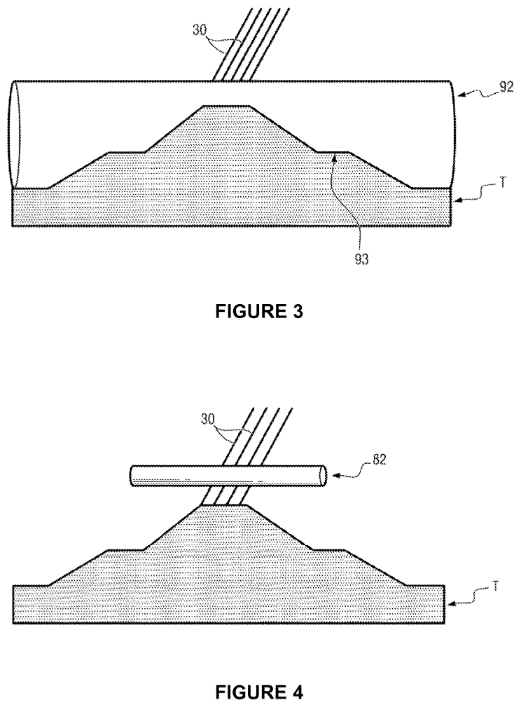

FIG. 3 illustrates a sectional view of the fabric of FIG. 2A and of a bar 92 of the holding device according to an embodiment of the invention.

The bearing surface 93, which comes into contact with the fabric T, makes it possible to compress the assembly of warp and weft yarns and thus to reduce the expansion of the fabric.

By contrast, in a holding device of known type, as illustrated in FIG. 4, the surface of the jaw 82 facing the fabric is planar and cannot therefore come into contact with the entirety of the surface of the fabric or compress the fabric in a homogeneous manner.

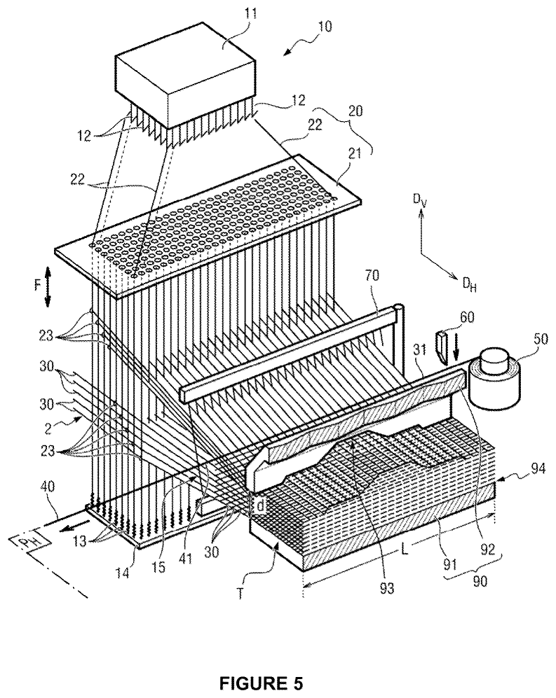

FIG. 5 illustrates a Jacquard loom 10 comprising a holding device according to the invention.

In a manner known per se, the loom 10 is equipped with a Jacquard mechanism 11 supported by a superstructure that is not shown in FIG. 5.

The loom 10 also comprises a harness 20 consisting of a bottom board 21 and heald wires or heddles 22, each heddle 22 being connected at one end to a control hook 12 of the Jacquard mechanism 11 and at the other end to one of the return springs 13 fixed to the frame 14 of the loom 10.

Each heddle 22 comprises an eye 23 passed through by a warp yarn 30. The heddles 22 and their associated eye 23 are driven with a substantially vertical oscillating movement represented by the double arrow F under the traction forces respectively exerted by the control hooks 12 and the return springs 13.

The heddles 22 make it possible to lift certain warp yarns 30 and to thus create a shed 15, in other words an opening between lower and upper sheets of warp yarns 30 enabling the introduction of weft yarns 31 by means of a rapier 40.

The rapier 40 is provided at its end with a clamp 41 which grasps a weft yarn 31 from a bobbin 50 in order to place it through the opening between the sheets of warp yarns 30 created by the shed 15, the weft yarn 31 being cut using a knife 60 after its positioning in the shed 15.

A comb 70 present upstream of the rapier 40 is then folded down in order to pack the one or more weft yarns introduced into the shed 15.

The rapier 40 is then ready to again grasp a new weft yarn 31 from the bobbin 50 and to place it either again in the shed 15, or in a different shed depending on the weaving defined.

The loom 10 further comprises a holding device 90 for the fabric T present downstream of the heddles 22 and the rapier 40.

According to the invention, said holding device 90 comprises two bearing surfaces 93, 94 arranged on either side of the fabric.

The bearing surface 93 facing the upper surface of the fabric, which is a shaped surface of the fabric, has a surface that is complementary to the surface of the fabric.

In the embodiment illustrated in FIG. 3, the shape of the bearing surface is complementary to the surface of the fabric provided that at any point on the width of the fabric, the distance between the bearing surface and the surface of the fabric is constant (this distance being zero when the bearing surface is in contact with the fabric). However, in other embodiments, the bearing surface could have a shape that is partially complementary to that of the surface of the fabric, in other words the distance between the bearing surface and the fabric could be constant in a part of the width of the fabric (for example a central part), but different in another part of the width of the fabric (for example a peripheral part). In other embodiments, the shape of the bearing surface might not perfectly coincide with the shape of the surface of the fabric, but have a shape intermediate between a planar shape and the shape of the surface of the fabric, this intermediate shape having a concavity oriented towards the surface of the fabric (in other words, if the surface of the fabric has a recess, the corresponding part of the bearing surface has a bulge and inversely, if the surface of the fabric has a bulge, the corresponding part of the bearing surface has a recess). In general, the relative deviation in distance between the bearing surface and the surface of the fabric along the width of the fabric is on average 30%, or even less than 10%.

Said bearing surface 93 belongs to a holding bar 92. The holding bar 92 can be integral with frame 14 of the loom 10.

Optionally, the loom can have a plurality of bearing surfaces each arranged on a respective holding bar, said holding bars being disposed in parallel with one another.

Furthermore, the bearing surface 93 is not necessarily continuous. For example, said bearing surface can extend over at least two parallel holding bars.

In the embodiment illustrated in FIG. 5, the bearing surface 94 facing the lower surface of the fabric, which is planar, belongs to a table 91 integral with the frame 14.

Alternatively (not illustrated), if the surface opposite the fabric also has a non-planar shape, the table 91 can be replaced by one or more holding bars likewise having a bearing surface complementary to the lower surface of the fabric, and arranged opposite the bearing surface 93 of the holding bar 92 in a direction Z perpendicular to the main surface of the fabric.

The bearing surface 93 is thus specifically shaped to at least partially match the shape of the non-planar surface of the fabric.

In order to manufacture a 3D fabric having a different shape, it is sufficient to replace the one or more holding bars by one or two holding bars having a bearing surface complementary to that of the surface of the new fabric. It therefore involves a particularly simple modification of the loom. In order to simplify such a modification, the holding bars can be in the form of an assembly of a body integral with the frame of the loom and a removable portion carrying the bearing surface. The removable portion can, for example, be connected to the body by screws or any reversible connection means.

Furthermore, the distance d between the bearing surfaces 93 and 94 is chosen so as to apply the bearing surface against the surface of the fabric and to exert a compression force of the fabric between the holding bar 92 and the table 91, or, where applicable, between the two holding bars.

The holding bar and the table are produced in the form of structures sufficiently rigid to resist the compression force exerted on the fabric. For example, each holding bar (or, in the case of a disassemblable assembly, the removable portion of the holding bar) can be present in the form of a solid metal bar, in which the bearing surface is machined.

Due to the complementarity of the surfaces in contact, this compression is substantially homogeneous over the entire contact surface, and preferably over the entire width L of the fabric. The compression has the effect of compacting the warp and weft yarns in the direction of the thickness of the fabric (direction Z) and thus of reducing the expansion of the fabric.

The distance d between the bearing surfaces is generally fixed during weaving, the holding bar 92 and the table 91 being fixed with respect to the frame. However, this distance can optionally be adjusted, in particular during fine tuning of the weave, for example using shims of different thicknesses.

A person skilled in the art is able to define the force to be applied as a function of the structure of the fabric in order to obtain a minimum expansion. For example, the expansion of the fabric can be measured without applying compression by the holding device, and then progressively applying an increasing compression force by reducing the distance between the bearing surfaces until the required expansion is obtained.

In particular, it is possible to measure the expansion of the fabric for various distances between the bearing surfaces.

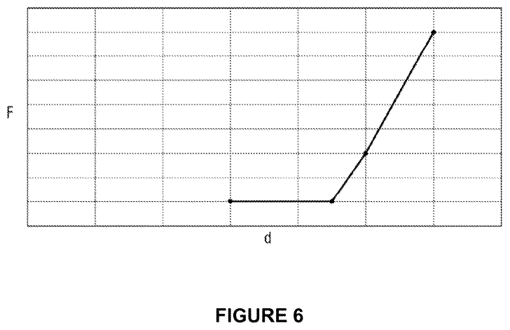

FIG. 6 thus schematically illustrates the expansion F for a fabric of the type shown in FIG. 2A, obtained empirically as a function of the distance d between the bearing surface of the holding bar and the bearing surface of the table. It is observed that the more the distance d is reduced, the more the expansion is reduced until a limit is reached (which may be non-zero) corresponding to the minimum expansion Fmin that it is possible to obtain for this fabric.

A person skilled in the art is therefore able, using simple tests, to determine the distance between the bearing surfaces in order to obtain a determined (preferably minimum) expansion for a given fabric.

The holding bar 92 is then fixed at a desired distance from the table 91.

Hence, a fabric T is gradually formed having a 3D multilayer weaving together of the warp yarns 30 and weft yarns 31 and having a minimum expansion, in other words the thickness of the fabric leaving the loom 10 is substantially equal to the intended thickness, while complying with the shape defined by the thickness variations.

In particular, in the case where the fabric is intended to form a preform or a reinforcement for manufacturing a composite object by the RTM method, the thickness of the fabric leaving the loom 10 is substantially equal to the thickness for which the mould has been designed.

In order to manufacture such a composite object, a certain length of the manufactured 3D fabric is provided by the loom 10, which constitutes a preform or a reinforcement.

Said reinforcement is placed in the imprint of the mould for the RTM method.

For example, in the case of a fan casing, the reinforcement is wound on a mandrel.

Even if the mandrel has a shape that cannot be developed, the reinforcement shape, due to the variations in thickness of the fabric, is suitable for minimising the formation of folds or bulges.

Furthermore, provided that the thickness of the reinforcement is identical to the intended thickness for the design of the mould, the closing of the mould does not cause pinching of the fabric.

Once the mould is again closed, a resin is injected into the imprint of the mould. The resin impregnates the mesh of the fabric.

The moulded composite object is held in the imprint for a duration sufficient to enable curing of the resin.

Then, the composite object is demoulded and any finishing treatments are carried out, which are conventional and will not therefore be described in the present text.

Reference can be made, in particular, to document EP 1 961 923 which describes a method for manufacturing a gas turbine casing made of composite material.

The quality of the composite object is substantially improved with respect to that of an object manufactured from a fabric for which the expansion has not been controlled during weaving. In particular, the absence of folds or bulges during placing in the imprint makes it possible to preserve the structure of the fabric at any point on the object, and thus to avoid changes in the local mechanical properties.

The invention has application for manufacturing of any type of casing or casing element having a rotationally symmetric shape, in particular for an aeronautical engine, such as a fan casing, a turbine casing, a nozzle casing or a mixer casing.

1. A loom for manufacturing a fabric having a variable thickness across a width of the fabric by weaving together a plurality of warp yarns and a plurality of weft yarns, the loom comprising:
a plurality of heald wires, connected to a mechanism capable of moving the heald wires in a vertical direction between a reference position and a first position for opening the warp yarns, each heald wire also being provided with an eye through which one of the warp yarns passes,
a rapier arranged downstream of the heald wires, capable of drawing a weft yarn from a bobbin, and
a holding device that holds the fabric arranged downstream of the plurality of heald wires and the rapier, comprising at least two bearing surfaces, including at least a first bearing surface and a second bearing surface arranged on either side of the fabric in order to compress the fabric between said first and second bearing surfaces,
wherein at least the first bearing surface is shaped so as to be at least partially complementary to a surface of the fabric.

2. The loom of claim 1, wherein the holding device comprises at least one holding bar having said at least one first bearing surface.

3. The loom of claim 2, wherein the at least one holding bar comprises a body and a removable portion carrying the first bearing surface, the removable portion being reversibly connected to the body of the holding bar.

4. The loom of claim 3, wherein the removable portion is in the form of a solid metal bar on which the first bearing surface is formed.

5. The loom of claim 1, wherein the holding device comprises a table having the second bearing surface, said second bearing surface being planar.

6. The loom of claim 1, wherein a distance between the first bearing surface and the second bearing surfaces is chosen so as to reduce an expansion of the fabric in order to reach a minimum expansion threshold.

7. The loom of claim 1, wherein the loom is configured for manufacturing a three-dimensional fabric.

8. A method for manufacturing a fabric, having a variable thickness over a width of the fabric, the method comprising:
weaving a plurality of warp yarns and a plurality of weft yarns by the loom according to claim 1, so as to form said fabric, and
applying, by the holding device, of a compression of the fabric by said first bearing surface and said second bearing surface.

9. The method of claim 8, wherein a distance between the first bearing surface and the second bearing surfaces is controlled so as to minimize an expansion of the fabric.

10. The method of claim 8, wherein the warp yarns and the weft yarns comprise carbon and/or glass.

11. A method for manufacturing of a composite object comprising a fabric, having a determined shape, the method comprising:
manufacturing said fabric by the method of claim 8;
winding a reinforcement formed of a portion of said fabric in an imprint of a mold defining an outer surface of the composite object;
closing the mold; and
introducing a resin into the imprint in order to impregnate the reinforcement.

12. The method of claim 11, wherein the composite object has a rotationally symmetric shape.

13. The method of claim 11, wherein the composite object is a fan casing, a turbine casing, a nozzle casing or a mixer casing for an aeronautical engine.

14. The loom according to claim 1, wherein the loom is a Jacquard loom.

15. The method according to claim 8, wherein the loom is a

16. The method according to claim 8, wherein the fabric is a three-dimensional fabric having the variable thickness over the width of the three-dimensional fabric.

17. The method according to claim 11, wherein the fabric is a three-dimensional fabric having the variable thickness over the width of the three-dimensional fabric.
